(19) United States
(12) Patent Application Publication
(10) Pub. No.: US 2021/0318831 A1
(43) Pub. Date: Oct. 14, 2021

(54) DATA STORAGE DEVICE WHICH CAN BE CONTROLLED REMOTELY AND REMOTE CONTROL SYSTEM

(71) Applicant: INNODISK CORPORATION, NEW TAIPEI CITY (TW)

(72) Inventors: CHIH-CHING WU, TAIPEI CITY (TW); CHIH-CHIEH KAO, NEW TAIPEI CITY (TW)

(21) Appl. No.: 17/036,358

(22) Filed: Sep. 29, 2020

(30) Foreign Application Priority Data
Apr. 10, 2020 (TW) 109112271

(51) Int. Cl. G06F 3/06

(52) U.S. Cl. CPC G06F 3/0655; G06F 3/0625; G06F 3/0679

(57) ABSTRACT

A remote control system is disclosed. The remote control system comprises a cloud management platform and an electronic apparatus. The electronic apparatus comprises a data storage device and a motherboard. The data storage device comprises a data storage unit and a program execution management unit. The program execution management unit comprises a microprocessor. The data storage device is connected a powered device module. The powered device module is able to provide an Ethernet power to the data storage device. When the electronic apparatus is in a power-off state, the data storage device can keep working by the Ethernet power, so that the cloud management platform can control the operations of the data storage device at any time.

This non-provisional application claims priority claim under 35 U.S.C. § 119(a) on Taiwan Patent Application No. 109112271 filed Apr. 10, 2020, the entire contents of which are incorporated herein by reference.

### FIELD OF THE INVENTION

The present invention relates to a remote control system, more particularly, a system capable of controlling a data storage device remotely.

### BACKGROUND

With the needs of life, unattended electronic devices such as vending machines, advertising machines, monitors, etc. are often seen on the road. In the past, the engineers wants to access or update data of a data storage device inside the electronic device, they must go to the installation location of the electronic apparatus in person. If the installation location of the electronic apparatus is very remote, it will cause a serious burden on the data accessing or updating of the electronic apparatus.

Nowadays, an advanced electronic apparatus is often equipped with a network communication module. The electronic apparatus is connected to a cloud management platform in internet via the network communication module, such that a manager of the cloud management platform can control the electronic apparatus remotely. The manager of the cloud management platform is usually to control or manage the electronic apparatus in a way of In-Band, it will need to perform in an operating environment of an operating system, and adopt a general data transmission channel (such as transmission channel of SATA or PCIe) to transmit the instructions to be used for controlling the electronic apparatus. When the cloud management platform controls or manages the electronic apparatus in the way of In-Band, once the electronic device shuts down, the manager of the cloud management platform cannot continue to perform any operations for the electronic apparatus. Therefore, it is necessary to send someone to go the installation location of the electronic apparatus to restart the electronic apparatus, so that the manager of the cloud management platform can continue to control the operations of the electronic apparatus after the electronic apparatus has been restarted.

### SUMMARY

It is one objective of the present invention to provide a data storage device which can be controlled remotely, in which the data storage device is disposed in an electronic apparatus and used as data storage medium, receives a specific operation instruction sent from a cloud management platform, and executes a corresponding program according to the specific operation instruction. The data storage device is connected to a powered device module for providing an Ethernet power. When the electronic apparatus is in power-off state, the data storage device can keep working by the Ethernet power provided by the powered device module, and therefore the cloud management platform can control the operations of the data storage device at any time.

It is another objective of the present invention to provide a data storage device which can be controlled remotely, in which the powered device module provides an Ethernet power, and a power supply of the electronic apparatus provides a host power. It can be decided by the switching of a power selector that a power energy required by the operations of the data storage device is provided by the Ethernet power or the host power.

It is another objective of the present invention to provide a remote control system, in which the remote control system comprises a cloud management platform and an electronic apparatus. The electronic apparatus comprises a data storage device having a program execution management unit. When the electronic apparatus is in a power-off state, the data storage device can keep working by an Ethernet power. Afterwards, when the cloud management platform further sends a boot up instruction to the data storage device, the program execution management unit of the data storage device will execute a boot up program of the electronic apparatus according to the boot up instruction, such that the electronic apparatus that was in the power-off state originally can be rebooted to enter a power-on state.

To achieve the above objective, the present invention provides a data storage device which can be controlled remotely, comprising: a data storage unit comprising a plurality of flash memories and a controller connected to the plurality of flash memories; a program execution management unit comprising a microprocessor and a network communication component connected to the microprocessor; and a power management module, connected to the data storage unit and the program execution management unit, and used to provide an operating voltage to the data storage unit and the program execution management unit, wherein the power management module is connected to a powered device module, the powered device module provides an Ethernet power to the power management module, and the power management module converts the Ethernet power to the operating voltage; wherein when the program execution management unit receives a specific operation instruction via the network communication component, the microprocessor of the program execution management device executes a corresponding operation program according to the specific operation instruction, or transmits the specific operation instruction to the data storage unit so as to request that the controller of the data storage unit executes the corresponding operation program according to the specific operation instruction.

In one embodiment of the present invention, the data storage device further comprises a data transmission interface and a power selector, the data transmission interface comprises a plurality of data pins and a plurality of power pins, the data transmission interface transmits a host power via at least one of the plurality of power pins; the power selector comprises a first power input end, a second power input end, and a power output end, the first power input end is connected to the powered device module, the second power input end is connected to the data transmission interface, the power output end is connected to the power management module, and a voltage detector is connected to the first power input end; when the voltage detector detects the Ethernet power on the first power input end, the power output end is electrically connected to the first power input end by a control of the voltage detector, and the Ethernet power is inputted to the power management module via the power selector; when the voltage detector does not detect the Ethernet power on the first power input end, the power output end is electrically connected to the second power input end by the control of the voltage detector, the host power is inputted to the power management module via the power selector, and the power management module converts the host power to the operating voltage.

In one embodiment of the present invention, the data transmission interface is a data transmission interface conforming to SATA, PCIe, or M2 transmission specification.

In one embodiment of the present invention, the data storage device further comprises a data transmission interface and a power selector, the data transmission interface comprises a plurality of data pins and a plurality of power pins, the data transmission interface transmits a host power via at least one of the plurality of power pins; the power selector comprises a first power input end, a second power input end, and a power output end, the first power input end is connected to the powered device module, the second power input end is connected to the data transmission interface, the power output end is connected to the power management module, and a voltage detector is connected to the second power input end; when the voltage detector detects the host power on the second power input end, the power output end is electrically connected to the second power input end by a control of the voltage detector, the host power is inputted to the power management module via the power selector, and the power management module converts the host power to the operating voltage; when the voltage detector does not detect the host power on the second power input end, the power output end is electrically connected to the first power input end by the control of the voltage detector, and the Ethernet power is inputted to the power management module via the power selector.

In one embodiment of the present invention, the powered device module is connected to a power sourcing equipment module via an Ethernet cable, the powered device module and the power sourcing equipment module are power modules conforming to a power over Ethernet standard specification; the power sourcing equipment module transmits the Ethernet power having a high voltage to the powered device module via the an Ethernet cable, and the powered device module converts the Ethernet power from the high voltage to a low voltage.

In one embodiment of the present invention, the powered device module comprises a first data transformer, a second data transformer, and a DC to DC converter, the DC to DC converter is connected to the first data transformer and the second data transformer; the power sourcing equipment module comprises a third data transformer, a fourth data transformer, and a direct current power chip, the direct current power chip is connected to the third data transformer and the fourth data transformer; the Ethernet cable comprises a first pair of conducting lines and a second pair of conducting lines, the first pair of conducting lines are connected between the first data transformer and the third data transformer, and the second pair of conducting lines are connected between the second data transformer and the fourth data transformer; the power sourcing equipment module provides the Ethernet power having the high voltage by the direct current power chip, and transmits the Ethernet power having the high voltage to the powered device module via the third data transformer, the fourth data transformer, the first pair of conducting lines, and the second pair of conducting lines; then, the powered device module receives the Ethernet power having the high voltage via the first data transformer and the second data transformer, and converts the Ethernet power from the high voltage to the low voltage via the DC to DC converter.

In one embodiment of the present invention, the network communication component is a WiFi communication component, an Ethernet communication component, or a 3G, 4G or 5G communication component.

The present invention further provides a remote control system, comprising: a cloud management platform; and an electronic apparatus, comprising: a motherboard; and a data storage device, comprising: a data transmission interface connected to the motherboard; a data storage unit comprising a plurality of flash memories and a controller connected to the plurality of flash memories and the data transmission interface; a program execution management unit comprising a network communication component and a microprocessor connected to the network communication component and the controller; and a power management module, connected to the data storage unit and the program execution management unit, and used to provide an operating voltage to the data storage unit and the program execution management unit; wherein the power management module is connected to a powered device module, the powered device module provides an Ethernet power to the power management module, and the power management module converts the Ethernet power to the operating voltage; wherein when the program execution management unit receives a specific operation instruction from the cloud management platform via the network communication component, the microprocessor of the program execution management device executes a corresponding operation program according to the specific operation instruction, or transmits the specific operation instruction to the data storage unit to request that the controller of the data storage unit executes the corresponding operation program according to the specific operation instruction.

In one embodiment of the present invention, the microprocessor further comprises a power-on pin connected to a power switch pin disposed on the motherboard, the specific operation instruction is a boot up instruction; when the electronic apparatus is in a power-off state and receives the boot up instruction, the microprocessor of the program execution management unit will send a boot up signal to the power switch pin via the power-on pin to execute a boot up program of the electronic apparatus.

### BRIEF DESCRIPTION OF THE DRAWINGS

FIG. 1 is an architecture diagram of a remote control system of the present invention.

FIG. 2 is a circuit diagram of a data storage device according to one application embodiment of the present invention.

FIG. 3 is a circuit diagram of Ethernet power supply architecture of the present invention.

FIG. 4 is an operation schematic of a power selector of the present invention.

FIG. 5 is another operation schematic of the power selector of the present invention.

FIG. 6 is a circuit diagram of the data storage device according to another application embodiment of the present invention.

FIG. 7 is a circuit diagram of the data storage device according to another application embodiment of the present invention.

FIG. 8 is a circuit diagram of the data storage device according to another application embodiment of the present invention.

### DETAILED DESCRIPTION OF THE PREFERRED EMBODIMENTS

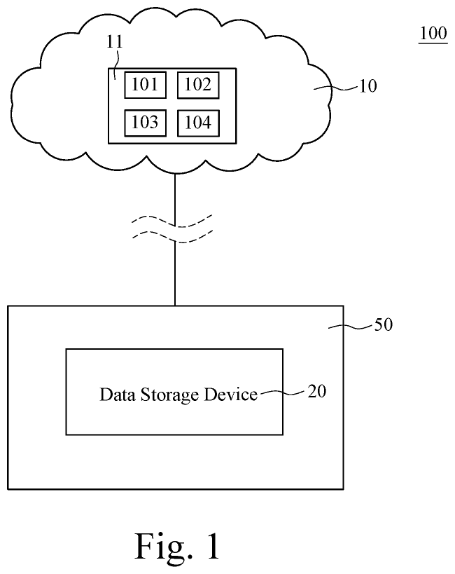

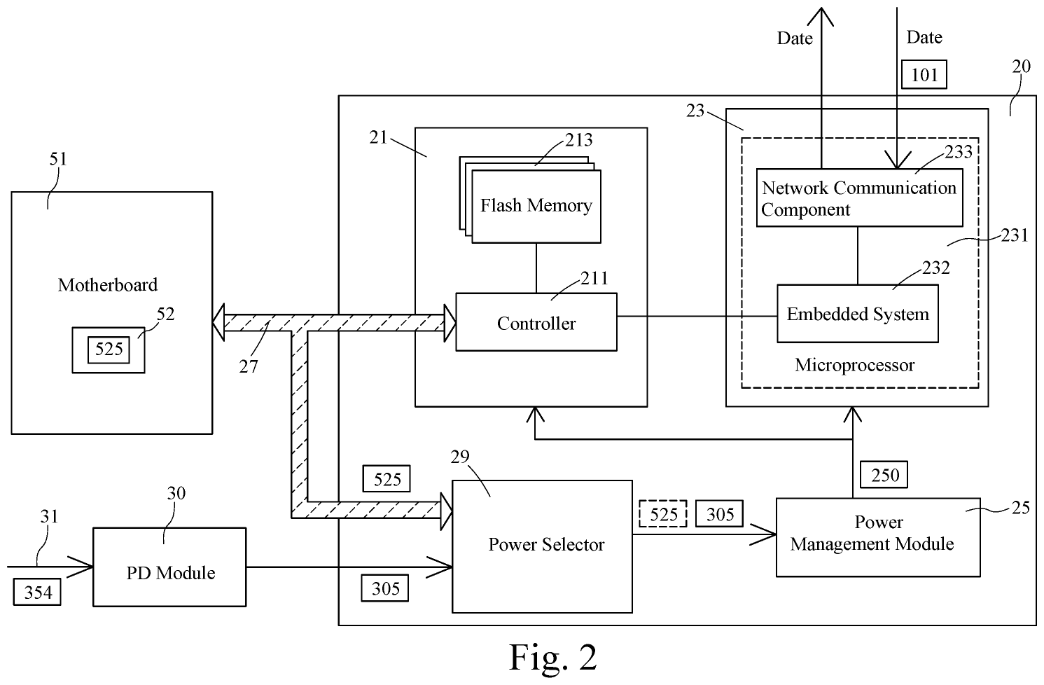

Referring to FIG. 1 and FIG. 2, there are shown an architecture diagram of a remote control system of the present invention, and a circuit diagram of a data storage device according to one application embodiment of the present invention, respectively. As shown in FIG. 1 and FIG. 2, the remote control system 100 of the present invention comprises a cloud management platform 10 and a data storage device 20. The data storage device 20 may be a solid state disk (SSD), or other forms of storage device capable of storing data. The data storage device 20 is disposed inside an electronic apparatus 50, and used as a data storage medium for the electronic apparatus 50.

The data storage device 20 comprises a data storage unit 21, a program execution management unit 23, and a power management module 25. The data storage unit 21 comprises a controller 211 and a plurality of flash memories 213. The controller 211 is connected to the flash memories 213. The program execution management unit 23 comprises a microprocessor 231. The microprocessor 231 is connected to the controller 211 of the data storage unit 21 via a connection line. The connection line may be a connection line conforming to RS232, UART, or I2C specification. The power management module 25 is connected to the data storage unit 21 and the program execution management unit 23, and provides an operating voltage 250 to the data storage unit 21 and the program execution management unit 23, so that the data storage unit 21 and the program execution management unit 23 can execute the operations via the power energy supplied by the operating voltage 250.

The microprocessor 231 is a chip with network communication function, for example, a network communication component 233 is integrated in the microprocessor 231. Otherwise, the microprocessor 231 and the network communication component 233 are independent components, respectively, and the microprocessor 231 is connected to the network communication component 233. The network communication component 233 is a WiFi communication component, an Ethernet communication component, a 3G, 4G or 5G communication component, or other networkable communication component. The program execution management unit 23 is communicated with the cloud management platform 10 via the network communication component 233. Besides, the microprocessor 231 is equipped with an embedded system 232, which is an architecture system of Linux or RTOS (such as QNX or VxWORKs), and is stored in non-volatile memories (NVMs).

The data storage device 20 of the present invention can be remotely controlled by the cloud management platform 10. A manager of the cloud management platform 10 may control the data storage device 20 to execute a specific operation program by the embedded system 232 of the microprocessor 231 of the data storage device 20. When the manager of the cloud management platform 10 wants the electronic apparatus 30 to execute a specific operation, it will sends a specific operation instruction 101, 102, 103, or 104 to the data storage device 20 by a management interface 11. The management interface 11 may be an application programming interface in WEB form (WEB App). After the data storage device 20 receives the specific operation instruction 101, 102, 103, or 104 via the network communication component 233 of the program execution management unit 23, the microprocessor 231 of the program execution management unit 23 executes a corresponding operation program according to the specific operation instruction 101, 102, 103, or 104, or the microprocessor 231 of the program execution management unit 23 transmits the specific operation instruction 101, 102, 103, or 104 to the data storage unit 21 to require that the controller 211 of the data storage unit 21 executes the corresponding operation program according to the specific operation instruction 101, 102, 103, or 104.

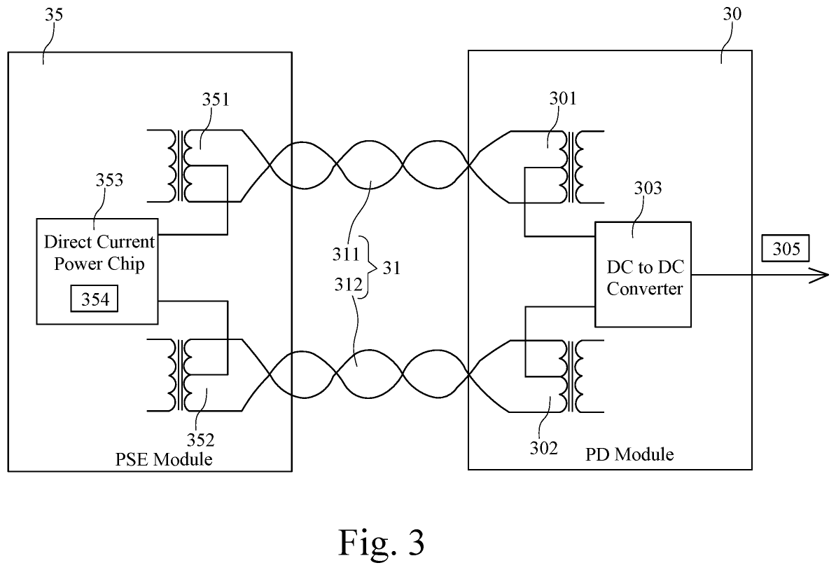

The power management module 25 is further connected to a powered device (PD) module 30. As shown in FIG. 3, the PD module 30 is connected to a power sourcing equipment (PSE) module 35 via an Ethernet cable 31. The PD module 30 and the PSE module 35 are power modules conforming to a Power over Ethernet (PoE) standard specification (such as IEEE 802.3af). The Ethernet cable 31 is an RJ45 network cable, and comprises a first pair of conducting lines 311 and a second pair of conducting lines 312. The PD module 30 comprises a first data transformer 301, a second data transformer 302, and a DC to DC converter 303. The DC to DC converter 303 is connected to the first data transformer 301 and the second data transformer 302. The PSE module 35 comprises a third data transformer 351, a fourth data transformer 352, and a direct current power chip 353. The direct current power chip 353 is connected to the third data transformer 351 and the fourth data transformer 352. The first pair of conducting lines 311 are connected between the first data transformer 301 and the third data transformer 351, and the second pair of conducting lines 312 are connected between the second data transformer 302 and the fourth data transformer 352. The PSE module 35 provides an Ethernet power 354 having a high voltage, for example, 48V. The Ethernet power 354 having the high voltage is transmitted to the PD module 30 via the third data transformer 351, the fourth data transformer 352, the first pair of conducting lines 311, and the second pair of conducting lines 312. Then, the PD module 30 receives the Ethernet power 354 having the high voltage via the first data transformer 301 and the second data transformer 302, and converts the Ethernet power 354 having the high voltage to an Ethernet power 305 having a low voltage via the DC to DC converter 303, for example, the voltage of the Ethernet power is converted from 48V to 5V or 3.3V. Afterwards, the PD module 30 inputs the Ethernet power 305 to the data storage device 20, and then the power management module 25 converts the Ethernet power 305 to the operating voltage 250 to provide a power energy required by the data storage device 20 in operating.

Accordingly, when the electronic apparatus 50 is in the power-off state, as long as the network connection of the Ethernet is normal, the data storage device 20 can keep working by the Ethernet power 305 provided by the PD module 30, and therefore the cloud management platform 10 can smoothly control the data storage device 20 to execute the specific operation program.

In one embodiment of the present invention, the PD module 30 is an external power supply module, and connected to a circuit board of the data storage device 20 via a power line. In another embodiment of the present invention, otherwise, the PD module 30 is directly disposed on the circuit board of the data storage device 20, and becomes an electronic component inside the data storage device 20.

The electronic apparatus 50 comprises a motherboard 51. The data storage device 20 further comprises a data transmission interface 27. The data transmission interface 27 is a data transmission interface conforming to SATA, PCIe, or M2 transmission specification, and comprises a plurality of data pins and a plurality of power pins. The data storage device 20 is connected to the motherboard 51 of the electronic apparatus 50 via the data transmission interface 27. A chip, for example, CPU, is disposed on the motherboard 51 of the electronic apparatus 50 can access data in the data storage device 20 via the data pins of the data transmission interface 27. A power supply 52 of the electronic apparatus 50 provides a host power 525 to the data storage device 20 via the motherboard 51. When the Ethernet is disconnected, the host power 525 is inputted to the data storage device 20 via the power pins of the data transmission interface 27, and then the power management module 25 converts the host power 525 to the operating voltage 250 to provide the power energy required by the data storage device 20 in operating.

The data storage device 20 further comprises a power selector 29. The power selector 29 comprises a first power input end 291, a second power input end 292, and a power output end 293. The first power input end 291 is connected to the PD module 30, the second power input end 292 is connected to the data transmission interface 27, and the power output end 293 is connected to the power management module 25. It can be decided by the switching of a power selector 29 that the Ethernet power 305 provided by the PD module 30 or the host power 525 provided by the power supply 52 is inputted to the data storage device 20.

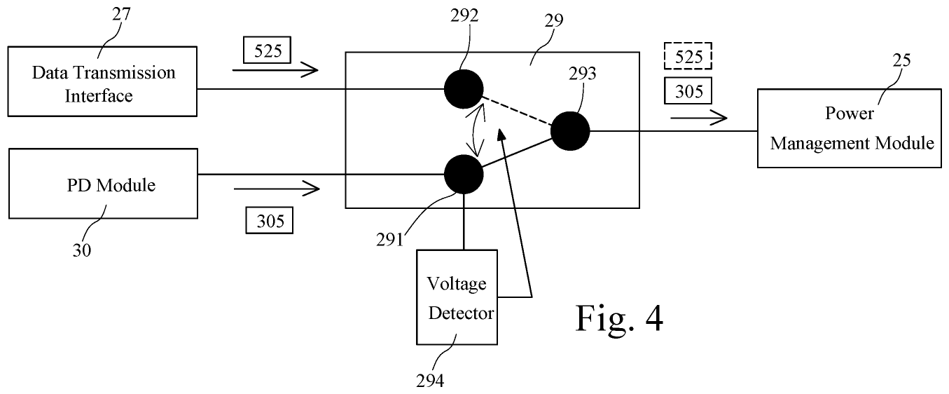

In one embodiment of the present invention, as shown in FIG. 4, the Ethernet power 305 is used as a main power of the data storage device 20, and the host power 525 is used as a backup power of the data storage device 20. A voltage detector 294 is connected to the first power input end 291 to detect whether the Ethernet power 305 exists. When the voltage detector 294 detects the Ethernet power 305 on the first power input end 291, the power output end 293 is electrically connected to the first power input end 291 by the voltage detector 294 controlling the switching of the power selector 29 such that the Ethernet power 305 is inputted to the power management module 25 via the power selector 29. On the contrary, when the voltage detector 294 does not detect the Ethernet power 305 on the first power input end 291, the power output end 293 is electrically connected to the second power input end 292 by the voltage detector 294 controlling the switching of the power selector 29 such that the host power 525 is inputted to the power management module 25 via the power selector 29.

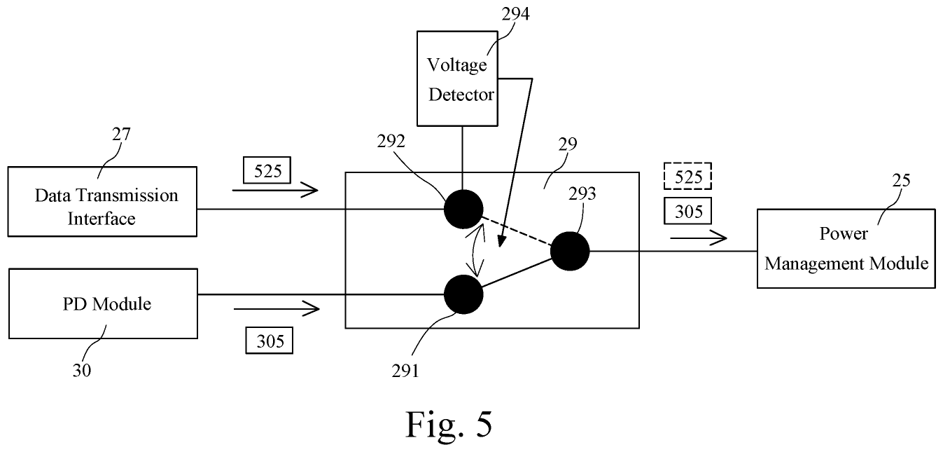

In another embodiment of the present invention, as shown in FIG. 5, the host power 525 is used as a main power of the data storage device 20, and the Ethernet power 305 is used as a backup power of the data storage device 20. The voltage detector 294 is connected to the second power input end 292 to detect whether the host power 525 exists. When the voltage detector 294 detects the host power 525 on the second power input end 292, the power output end 293 is electrically connected to the second power input end 292 by the voltage detector 294 controlling the switching of the power selector 29 such that the host power 525 is inputted to the power management module 25 via the power selector 29. On the contrary, when the voltage detector 294 does not detect the host power 525 on the second power input end 292, for example, the electronic apparatus 50 is in power-off state, the power output end 293 is electrically connected to the first power input end 291 by the voltage detector 294 controlling the switching of the power selector 29 such that the Ethernet power 305 is inputted to the power management module 25 via the power selector 29.

Following the above description, the cloud management platform 10 of the present invention sends the specific operation instruction 101, 102, 103, or 104 to the data storage device 20 to remotely control the operations of the data storage device 20. In one application embodiment, as shown in FIG. 1 and FIG. 2, the specific operation instruction 101 is a data accessing instruction. When the program execution management unit 23 receives the operation instruction 101, the microprocessor 231 of the program execution management unit 23 requires the controller 211 to read data from the flash memories 213, or write data to the flash memories 213. Accordingly, whether the electronic apparatus 50 is in a power-on state or a power-off state, the cloud management platform 10 can read data from the data storage device 20 or write data into the data storage device 20 by the program execution unit 23 of the data storage device 20, remotely.

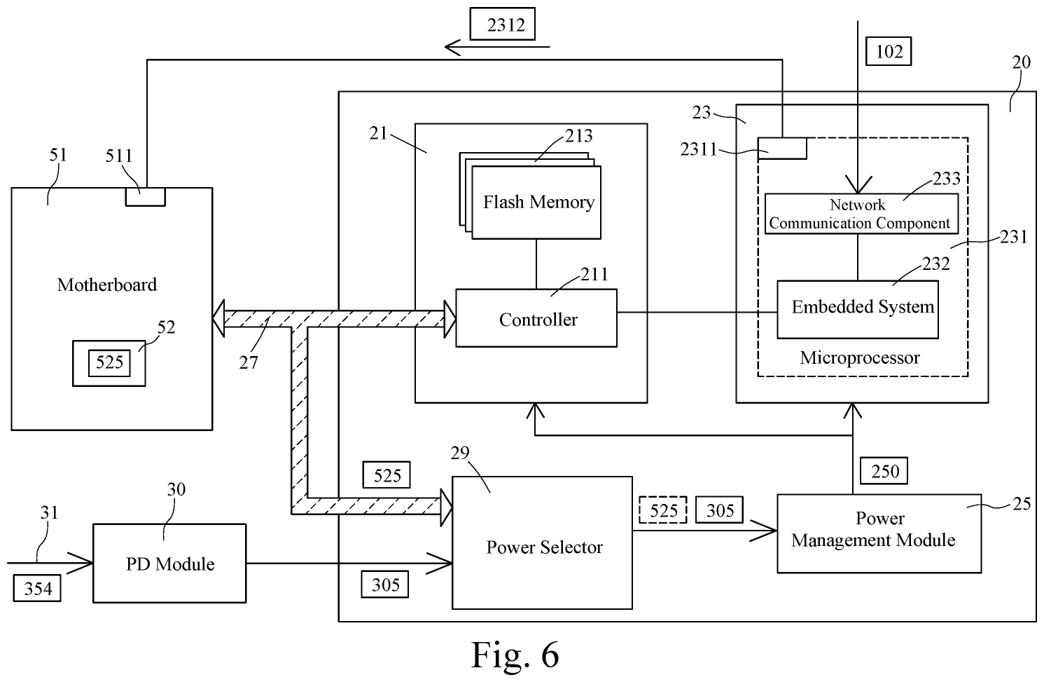

Referring to FIG. 6, there is shown the circuit diagram of the data storage device according to another application embodiment of the present invention, and simultaneously referring to FIG. 1. As shown in FIG. 1 and FIG. 6, in the application embodiment of the present invention, the manager of the cloud management platform 10 can control the electronic apparatus 50 in the power-off state to execute a boot up operation, and the operation instruction 102 send by the management interface 11 of the cloud management platform 10 is a boot up instruction. The microprocessor 231 comprises a power-on pin 2311. A power switch pin 511 is disposed on the motherboard 51, and connected to the power-on pin 2311. When the program execution management unit 23 receives the operation instruction 102, the microprocessor 231 of the program execution management unit 23 sends a boot up signal 2312 to the power switch pin 511 via the power-on pin 2311 to execute a boot up program for the electronic apparatus 50, such that the electronic apparatus 50 that was in the power-off state originally can be rebooted to enter a power-on state. Accordingly, when the electronic apparatus 50 is in the power-off state, the cloud management platform 10 can execute the boot up operation of the electronic apparatus 50 by the program execution management unit 23 of the data storage device 20, remotely.

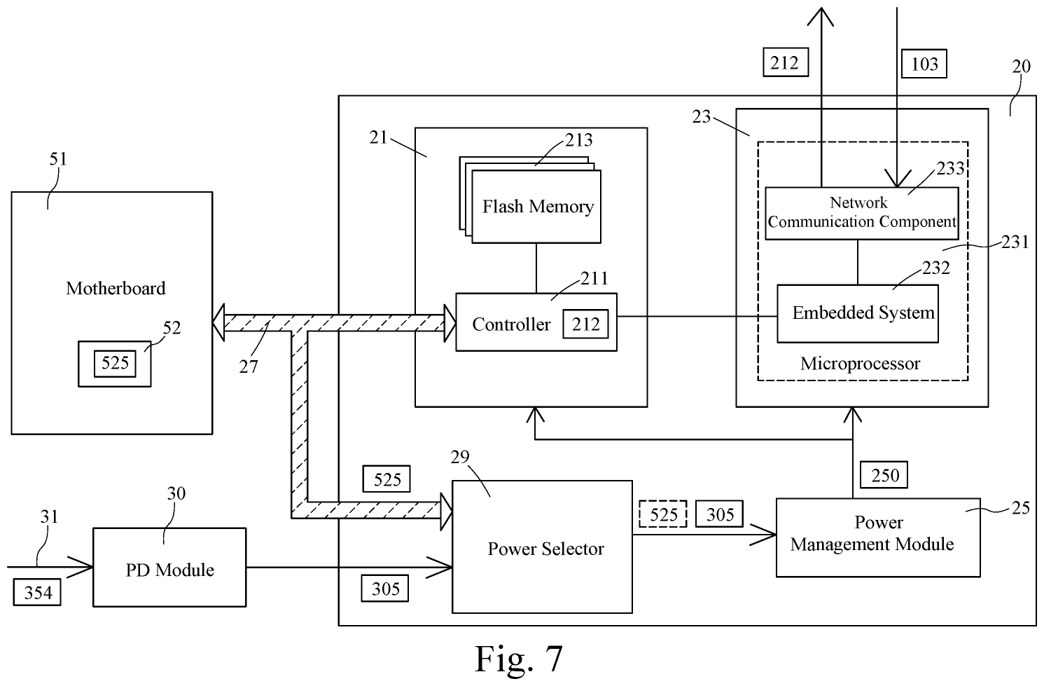

Referring to FIG. 7, there is shown the circuit diagram of the data storage device according to another application embodiment of the present invention, and simultaneously referring to FIG. 1. As shown in FIG. 1 and FIG. 7, in another application embodiment of the present invention, for monitoring a service life of the data storage device 20, the manager of the cloud management platform 10 can control that the electronic apparatus 50 executes an operation for collecting health information of the data storage device 20, and therefore send the operation instruction 103 for collecting health information to the electronic apparatus 50. After the data storage device 20 receives the operation instruction 103 via the network communication component 233, the microprocessor 231 of the program execution management unit 23 transmits the operation instruction 103 to the controller 211, and then the controller 211 executes an operation program for collecting health information of the data storage device 20 according to the requirement of the operation instruction 103. The controller 211 generates a file 212 containing the health information of the data storage device 20 after the health information of the data storage device 20 has collected. The program execution management unit 23 receives the file 212 from the controller 211, and transmits the file 212 to the cloud management platform 10 via the network communication component 233. The health information in the file 212 will display on the management interface 11 of the cloud management platform 10 after the cloud management platform 10 receives the file 212. Accordingly, whether the electronic apparatus 50 is in the power-on state or the power-off state, the data storage device 20 can keep working by the Ethernet power 305 so that the manager of the cloud management platform 10 can collect the health information of the data storage device 20 by the program execution management unit 23 of the data storage device 20 at any time, and decide whether to replace the data storage device 20 of the electronic apparatus 50 according to the result of analysis of the health information of the file 212.

During the controller 211 reading data from the flash memories 213 or writing data into the flash memories 213, the controller 211 has also recorded some parameters related to the health information of the data storage device 20, such as Raw Bit Error Rate (RBER), Program/Erase cycle (P/E cycle), average erase count, later bad block count, program fail count, unexpected power loss, etc., and these parameters of health information are recorded in the flash memories 213. Afterwards, when the controller 211 executes the operation program for collecting the health information of the data storage device 20, it may capture these parameters of health information from the flash memories 213, and therefore generate the file 212 containing the health information of the data storage device 20.

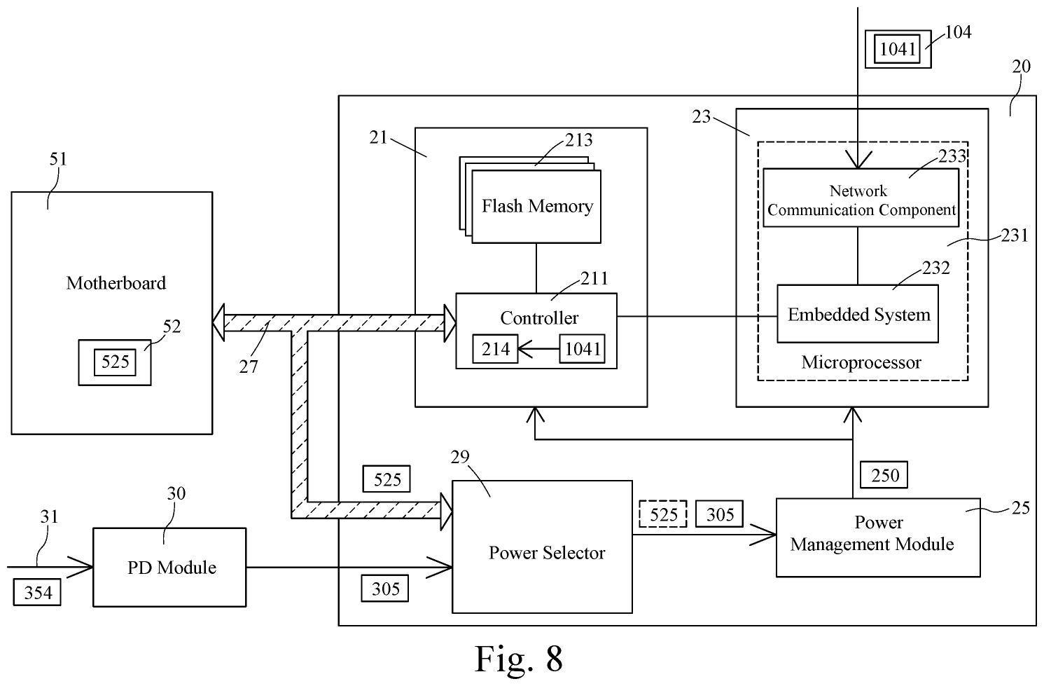

Referring to FIG. 8, there is shown the circuit diagram of the data storage device according to another application embodiment of the present invention, and simultaneously referring to FIG. 1. As shown in FIG. 1 and FIG. 8, in the present embodiment, the manager of the cloud management platform 10 can execute an updating firmware operation of the electronic apparatus 20, and the operation instruction 104 send by the management interface 11 of the cloud management platform 10 is an updating firmware instruction includes a firmware updating file 1041. After the data storage device 20 receives the operation instruction 104 via the network communication component 233, the microprocessor 231 of the program execution management unit 23 transmits the operation instruction 104 to the controller 211 to require the controller 211 to execute an updating firmware program according to the operation instruction 104. Thus, the controller 211 can update the firmware 214 by the firmware updating file 1041 in the operation instruction 104. Accordingly, whether the electronic apparatus 50 is in the power-on state or the power-off state, the data storage device 20 can keep working by the Ethernet power 305 so that the manager of the cloud management platform 10 can execute the updating firmware operation of the data storage device 20 at any time.

The four embodiments in the above described are only partially implementation of the present invention. In actual application, whether the electronic apparatus 50 is in the power-on state or the power-off state, the manager of the cloud management platform 10 can control the data storage device 20 to execute a variety of operation programs by the program execution management unit 23 of the data storage device 20 at any time. For example, updating or repairing an operating system of the electronic apparatus 50, or controlling the operations of workpieces of the electronic apparatus 50.

The above disclosure is only the preferred embodiment of the present invention, and not used for limiting the scope of the present invention. All equivalent variations and modifications on the basis of shapes, structures, features and spirits described in claims of the present invention should be included in the claims of the present invention.

What is claimed is:

1. A data storage device which can be controlled remotely, comprising:
a data storage unit comprising a plurality of flash memories and a controller connected to the plurality of flash memories;
a program execution management unit comprising a microprocessor and a network communication component connected to the microprocessor; and
a power management module, connected to the data storage unit and the program execution management unit, and used to provide an operating voltage to the data storage unit and the program execution management unit, wherein the power management module is connected to a powered device module, the powered device module provides an Ethernet power to the power management module, and the power management module converts the Ethernet power to the operating voltage;
wherein when the program execution management unit receives a specific operation instruction via the network communication component, the microprocessor of the program execution management device executes a corresponding operation program according to the specific operation instruction, or transmits the specific operation instruction to the data storage unit so as to request that the controller of the data storage unit executes the corresponding operation program according to the specific operation instruction.

2. The data storage device according to claim 1, wherein the data storage device further comprises a data transmission interface and a power selector, the data transmission interface comprises a plurality of data pins and a plurality of power pins, the data transmission interface transmits a host power via at least one of the plurality of power pins; the power selector comprises a first power input end, a second power input end, and a power output end, the first power input end is connected to the powered device module, the second power input end is connected to the data transmission interface, the power output end is connected to the power management module, and a voltage detector is connected to the first power input end; when the voltage detector detects the Ethernet power on the first power input end, the power output end is electrically connected to the first power input end by a control of the voltage detector, and the Ethernet power is inputted to the power management module via the power selector; when the voltage detector does not detect the Ethernet power on the first power input end, the power output end is electrically connected to the second power input end by the control of the voltage detector, the host power is inputted to the power management module via the power selector, and the power management module converts the host power to the operating voltage.

3. The data storage device according to claim 2, wherein the data transmission interface is a data transmission interface conforming to SATA, PCIe, or M2 transmission specification.

4. The data storage device according to claim 1, wherein the data storage device further comprises a data transmission interface and a power selector, the data transmission interface comprises a plurality of data pins and a plurality of power pins, the data transmission interface transmits a host power via at least one of the plurality of power pins; the power selector comprises a first power input end, a second power input end, and a power output end, the first power input end is connected to the powered device module, the second power input end is connected to the data transmission interface, the power output end is connected to the power management module, and a voltage detector is connected to the second power input end; when the voltage detector detects the host power on the second power input end, the power output end is electrically connected to the second power input end by a control of the voltage detector, the host power is inputted to the power management module via the power selector, and the power management module converts the host power to the operating voltage; when the voltage detector does not detect the host power on the second power input end, the power output end is electrically connected to the first power input end by the control of the voltage detector, and the Ethernet power is inputted to the power management module via the power selector.

5. The data storage device according to claim 4, wherein the data transmission interface is a data transmission interface conforming to SATA, PCIe, or M2 transmission specification.

6. The data storage device according to claim 1, wherein the powered device module is connected to a power sourcing equipment module via an Ethernet cable, the powered device module and the power sourcing equipment module are power modules conforming to a power over Ethernet standard specification; the power sourcing equipment module transmits the Ethernet power having a high voltage to the powered device module via the an Ethernet cable, and the powered device module converts the Ethernet power from the high voltage to a low voltage.

7. The data storage device according to claim 6, wherein the powered device module comprises a first data transformer, a second data transformer, and a DC to DC converter, the DC to DC converter is connected to the first data transformer and the second data transformer; the power sourcing equipment module comprises a third data transformer, a fourth data transformer, and a direct current power chip, the direct current power chip is connected to the third data transformer and the fourth data transformer; the Ethernet cable comprises a first pair of conducting lines and a second pair of conducting lines, the first pair of conducting lines are connected between the first data transformer and the third data transformer, and the second pair of conducting lines are connected between the second data transformer and the fourth data transformer; the power sourcing equipment module provides the Ethernet power having the high voltage by the direct current power chip, and transmits the Ethernet power having the high voltage to the powered device module via the third data transformer, the fourth data transformer, the first pair of conducting lines, and the second pair of conducting lines; then, the powered device module receives the Ethernet power having the high voltage via the first data transformer and the second data transformer, and converts the Ethernet power from the high voltage to the low voltage via the DC to DC converter.

8. The data storage device according to claim 1, wherein the network communication component is a WiFi communication component, an Ethernet communication component, or a 3G 4G or 5G communication component.

9. A remote control system, comprising:
a cloud management platform; and
an electronic apparatus, comprising:
a motherboard; and
a data storage device, comprising:
a data transmission interface connected to the motherboard;
a data storage unit comprising a plurality of flash memories and a controller connected to the plurality of flash memories and the data transmission interface;
a program execution management unit comprising a network communication component and a microprocessor connected to the network communication component and the controller; and
a power management module, connected to the data storage unit and the program execution management unit, and used to provide an operating voltage to the data storage unit and the program execution management unit; wherein the power management module is connected to a powered device module, the powered device module provides an Ethernet power to the power management module, and the power management module converts the Ethernet power to the operating voltage;
wherein when the program execution management unit receives a specific operation instruction from the cloud management platform via the network communication component, the microprocessor of the program execution management device executes a corresponding operation program according to the specific operation instruction, or transmits the specific operation instruction to the data storage unit to request that the controller of the data storage unit executes the corresponding operation program according to the specific operation instruction.

10. The remote control system according to claim 9, wherein the data storage device further comprises a power selector, the data transmission interface comprises a plurality of data pins and a plurality of power pins, the data transmission interface transmits a host power via at least one of the plurality of power pins; the power selector comprises a first power input end, a second power input end, and a power output end, the first power input end is connected to the powered device module, the second power input end is connected to the data transmission interface, the power output end is connected to the power management module, and a voltage detector is connected to the first power input end; when the voltage detector detects the Ethernet power on the first power input end, the power output end is electrically connected to the first power input end by a control of the voltage detector, and the Ethernet power is inputted to the power management module via the power selector; when the voltage detector does not detect the Ethernet power on the first power input end, the power output end is electrically connected to the second power input end by the control of the voltage detector, the host power is inputted to the power management module via the power selector, and the power management module converts the host power to the operating voltage.

11. The remote control system according to claim 9, wherein the data storage device further comprises a power selector, the data transmission interface comprises a plurality of data pins and a plurality of power pins, the data transmission interface transmits a host power via at least one of the plurality of power pins; the power selector comprises a first power input end, a second power input end, and a power output end, the first power input end is connected to the powered device module, the second power input end is connected to the data transmission interface, the power output end is connected to the power management module, and a voltage detector is connected to the second power input end; when the voltage detector detects the host power on the second power input end, the power output end is electrically connected to the second power input end by a control of the voltage detector, the host power is inputted to the power management module via the power selector, and the power management module converts the host power to the operating voltage; when the voltage detector does not detect the host power on the second power input end, the power output end is electrically connected to the first power input end by the control of the voltage detector, and the Ethernet power is inputted to the power management module via the power selector.

12. The remote control system according to claim 9, wherein the powered device module is connected to a power sourcing equipment module via an Ethernet cable, the powered device module and the power sourcing equipment module are power modules conforming to a power over Ethernet standard specification; the power sourcing equipment module transmits the Ethernet power having a high voltage to the powered device module via the an Ethernet cable, and the powered device module converts the Ethernet power from the high voltage to a low voltage.

13. The remote control system according to claim 12, wherein the powered device module comprises a first data transformer, a second data transformer, and a DC to DC converter, the DC to DC converter is connected to the first data transformer and the second data transformer; the power sourcing equipment module comprises a third data transformer, a fourth data transformer, and a direct current power chip, the direct current power chip is connected to the third data transformer and the fourth data transformer; the Ethernet cable comprises a first pair of conducting lines and a second pair of conducting lines, the first pair of conducting lines are connected between the first data transformer and the third data transformer, and the second pair of conducting lines are connected between the second data transformer and the fourth data transformer; the power sourcing equipment module provides the Ethernet power having the high voltage by the direct current power chip, and transmits the Ethernet power having the high voltage to the powered device module via the third data transformer, the fourth data transformer, the first pair of conducting lines, and the second pair of conducting lines; then, the powered device module receives the Ethernet power having the high voltage via the first data transformer and the second data transformer, and converts the Ethernet power from the high voltage to the low voltage via the DC to DC converter.

14. The remote control system according to claim 9, wherein the microprocessor further comprises a power-on pin connected to a power switch pin disposed on the motherboard, the specific operation instruction is a boot up instruction; when the electronic apparatus is in a power-off state and receives the boot up instruction, the microprocessor of the program execution management unit will send a boot up signal to the power switch pin via the power-on pin to execute a boot up program of the electronic apparatus.
